(19) United States
(12) Patent Application Publication
(10) Pub. No.: US 2026/0170604 A1
(43) Pub. Date: Jun. 18, 2026

(54) SEMICONDUCTOR DEVICE

(71) Applicant: Renesas Electronics Corporation, Tokyo (JP)

(72) Inventor: Hideyuki KOBAYASHI, Tokyo (JP)

(21) Appl. No.: 19/422,045

(22) Filed: Dec. 16, 2025

(30) Foreign Application Priority Data
Dec. 17, 2024 (JP) 2024-220840

(51) Int. Cl. G06T 3/40; G06T 1/60; G06V 10/25

(52) U.S. Cl. CPC G06T 3/40; G06T 1/60; G06V 10/25

(57) ABSTRACT

A semiconductor device includes a parameter storage unit and an image processing circuit. The image processing circuit includes a scaling calculation unit that changes a size of an input image based on an enlargement ratio or reduction ratio set in scale factor setting information. The image processing circuit further includes an optimized image area calculation unit that calculates a necessary image area size for outputting an output image based on an output size of the output image and a scale factor, and an input image area comparison unit that compares the necessary image area size with the input size of the input image, selects an image area with a smaller size out of the necessary image area size and the input size, and uses the image area selected for the image processing of the input image.

### CROSS-REFERENCE TO RELATED APPLICATIONS

The disclosure of Japanese Patent Application No. 2024-220840 filed on Dec. 17, 2024 including the specification, drawings and abstract is incorporated herein by reference in its entirety.

### BACKGROUND

The present disclosure relates to a semiconductor device, and for example, relates to a technology of a semiconductor device including an image processing circuit.

There is disclosed a technique listed below.
[Patent Document 1] Japanese Unexamined Patent Application Publication No. 2011-59911

A technique of reducing the size and power consumption of a circuit for changing the order of image processing is known (see Patent Document 1).

### SUMMARY

In recent years, high definition of image quality has been achieved. In such a situation, in a semiconductor device including an image processing circuit, the amount of information to be delivered for performing image processing with a memory is increasing. For this reason, the load on the image processing circuit included in the semiconductor device has increased.

Other problems and novel features will become apparent from the description of the present specification and the accompanying drawings.

A representative embodiment of the present disclosure has the following configuration. A semiconductor device according to an embodiment includes an image processing circuit. The image processing circuit calculates a necessary image area size for outputting an output image based on an output size of an output image and a scale factor. The image processing circuit compares the necessary image area size with an input size of an input image, selects an image area with a smaller size out of the necessary image area size and the input size, and uses the image area selected for image processing of the input image.

According to the representative embodiment of the present disclosure, it is possible to provide a technique capable of reducing the load on the image processing circuit in the semiconductor device.

### BRIEF DESCRIPTION OF THE DRAWINGS

FIG. 1 is a diagram schematically illustrating an example of a configuration of a semiconductor device according to an embodiment.

FIG. 2 is a diagram for explaining an example of image processing of the semiconductor device according to the embodiment.

FIG. 3 is a flowchart illustrating an example of the image processing of the semiconductor device according to the embodiment.

FIG. 4 is a diagram for explaining an example of an image area in the embodiment.

FIG. 5 is a diagram illustrating an example of an unnecessary image area in the case illustrated in FIG. 4.

FIG. 6 is a diagram illustrating an example of stored information of a descriptor list in the embodiment.

FIG. 7 is a diagram illustrating relationship information that is an example of the relationship between a parameter and an address of a storage destination in the embodiment.

FIG. 8 is a diagram illustrating an image area of an input image in a first example.

FIG. 9 is a diagram illustrating a scale factor and an image area of an enlarged image in the first example.

FIG. 10 is a diagram illustrating an image area of an output image in the first example.

FIG. 11 is a diagram illustrating an image area after optimization calculation in the first example.

FIG. 12 is a diagram illustrating an image area after comparative update in the first example.

FIG. 13 is a schematic diagram illustrating an example of specifications and calculation results in the first example.

FIG. 14 is a diagram comparing the output image area in the first example with an output image area in a second example.

FIG. 15 is a diagram illustrating an example of stored information of a descriptor list in the second example.

FIG. 16 is a schematic diagram illustrating an example of specifications and calculation results in the second example.

### DETAILED DESCRIPTION

Hereinafter, an embodiment of the present disclosure will be described in detail with reference to the drawings. In the drawings, the same parts are denoted by the same reference numerals in principle, and repeated description is omitted. In the drawings, the expressions of the components may not represent actual positions, sizes, shapes, ranges, and the like in order to facilitate understanding of the invention.

### Embodiment

### Configuration of Semiconductor Device

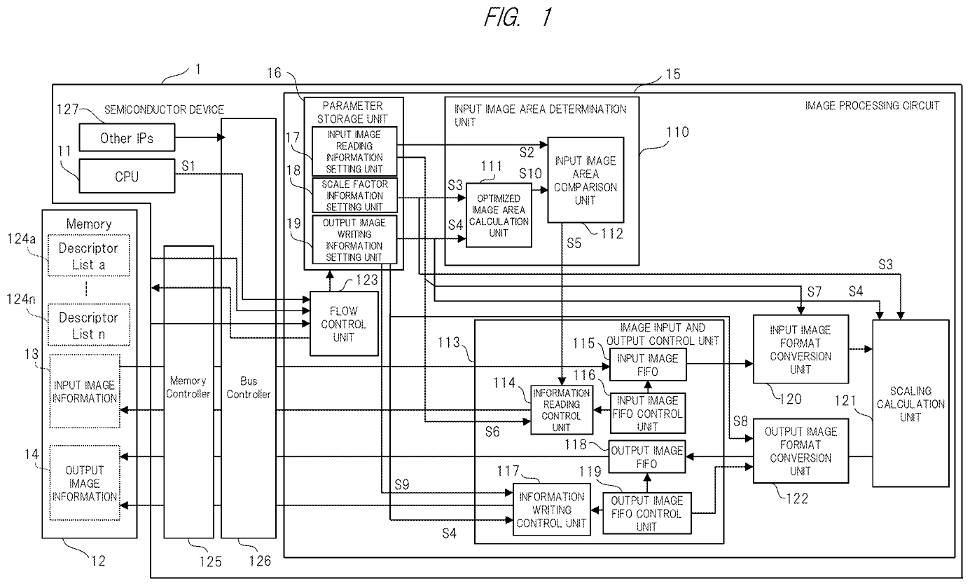

FIG. 1 is a diagram schematically illustrating an example of a configuration of a semiconductor device 1. The semiconductor device 1 is connected to a memory 12. The semiconductor device 1 receives image information from the memory 12 and outputs the image information to the memory. The semiconductor device 1 is a semiconductor device that processes image information. In the present embodiment, a case where the memory 12 is provided separately from the semiconductor device 1 will be described, but the memory 12 may be configured to be included in the semiconductor device 1.

As illustrated in FIG. 1, the semiconductor device 1 includes an image processing circuit 15, a CPU 11, a memory controller 125, a bus controller 126, and other IPs 127. The CPU 11 and the other IPs 127 communicate with the image processing circuit 15 via the bus controller 126. The image processing circuit 15 communicates with the memory 12 via the bus controller 126 and the memory controller 125.

The memory 12 stores descriptor lists 124a to 124n, input image information 13, and output image information 14. Each of the descriptor lists 124a to 124n includes input image setting information, scale factor setting information, output image setting information, and parameter lists. The input image setting information includes the input size of an image area of an input image input from the memory 12 to the image processing circuit 15. The scale factor setting information includes a scale factor for setting the scale factor of the input image. The output image setting information includes the output size of an image area of an output image output from the image processing circuit 15 to the memory 12. The parameter lists include parameters in which next frame designation information is stored. The designation information is, for example, a parameter for designating a frame on which processing of an input image is performed next. The input image information 13 is information of an input image input to the image processing circuit 15. The output image information 14 is information of an output image output from image processing circuit 15.

The information stored in the descriptor lists 124a to 124n is set by the image processing circuit 15 in a setting unit to be described later in the image processing circuit 15 before the input image is read from the memory 12. For example, the input image setting information is set in an input image reading information setting unit 17 (first setting unit). The scale factor setting information is set in a scale factor information setting unit 18 (second setting unit). The output image setting information is set in an output image writing information setting unit 19 (third setting unit). The memory 12 includes a plurality of descriptor lists 124. The image processing circuit 15 performs image processing on the input image based on the above designation information included in the descriptor list. Details of these pieces of processing will be described later.

The image processing circuit 15 performs, on the input image input from the memory 12, processing of changing the size of the image based on a specified scale factor. The CPU 11 is a processor that designates necessary setting information for the image processing circuit 15. The other IPs 127 are other IPs that make an access request to the memory 12. The memory controller 125 executes read control or write control on the information stored in the memory 12. The bus controller 126 adjusts the priority order of buses between the image processing circuit 15 and various IPs such as the CPU 11, and transmits and receives information to and from the memory controller 125.

The image processing circuit 15 includes a parameter storage unit 16, an input image area determination unit 110, an image input and output control unit 113, an input image format conversion unit 120, a scaling calculation unit 121, an output image format conversion unit 122, and a flow control unit 123. The parameter storage unit 16 includes, for example, a register that stores information. The input image area determination unit 110, the image input and output control unit 113, the input image format conversion unit 120, the scaling calculation unit 121, the output image format conversion unit 122, and the flow control unit 123 include, for example, circuits.

The parameter storage unit 16 stores various setting parameters in the image processing circuit 15. The parameter storage unit 16 includes the input image reading information setting unit 17 (first setting unit), the scale factor information setting unit 18 (second setting unit), and the output image writing information setting unit 19 (third setting unit).

The input image setting information is set in the input image reading information setting unit 17. More specifically, for the input image information 13 on the memory 12 in a case where an input image is read, information indicating a start position, an image size, an image format, and the like are set in the input image reading information setting unit 17.

In the scale factor information setting unit 18, what enlargement ratio or reduction ratio is used to perform calculations on the input image (corresponding to the input image information 13) is set.

The output image setting information is set in the output image writing information setting unit 19. More specifically, in a case where the output image information 14 is written, information indicating a start position on the memory 12, an image size, an image format, and the like are set in the output image writing information setting unit 19. The image size (output size) is determined based on the display size of a device connected to the semiconductor device 1, for example, a liquid crystal display device. Furthermore, the image size is determined, for example, based on processing at the subsequent stage of the image processing circuit 15. The subsequent processing corresponds to processing of the other IPs 127 to be described later in the present embodiment.

The input image area determination unit 110 makes a determination as to reduction of read image area for the input image input to the image processing circuit 15. The input image area determination unit 110 includes an optimized image area calculation unit 111 and an input image area comparison unit 112.

The optimized image area calculation unit 111 calculates a truly necessary image area on the basis of the output image writing information set in the output image writing information setting unit 19 and the scale factor information from the scale factor information setting unit 18. For example, the optimized image area calculation unit 111 calculates the necessary image area size for outputting the output image on the basis of the output size of the output image information 14 and the scale factor. In the present embodiment, the optimized image area calculation unit 111 calculates the necessary image area size by dividing the output size of the output image information 14 by the scale factor. Details of the processing will be described later.

When determining that optimization can be performed such that the image area of the output image can be reduced on the basis of the calculation result of the optimized image area calculation unit 111, the input image area comparison unit 112 updates the value of the input image reading information setting unit 17. For example, the input image area comparison unit 112 compares the necessary image area size calculated by the optimized image area calculation unit 111 with the input size of the input image information 13. In comparison, the input image area comparison unit 112 selects an image area with a smaller size out of the necessary image area size and the input size of the input image information 13, and uses the selected image area for image processing of the input image. Details of the processing will be described later.

In a case where image processing is performed in the image processing circuit 15, the image input and output control unit 113 manages internal timings of reading information from an address specified in the memory 12 and writing information to the designated address. The image input and output control unit 113 includes an information reading control unit 114, an input image FIFO 115, an input image FIFO control unit 116, an information writing control unit 117, an output image FIFO 118, and an output image FIFO control unit 119.

The information reading control unit 114 executes control to read the input image information 13 from the memory 12. The input image FIFO 115 temporarily stores information read from the memory 12 under the control of the information reading control unit 114, and transfers the stored information to the subsequent input image format conversion unit 120 based on the timing of the internal image processing. The input image FIFO control unit 116 checks the free space in the input image FIFO 115, and transmits a start instruction to the information reading control unit 114. The information writing control unit 117 executes control to write the output image information 14 in the memory 12. The output image FIFO 118 temporarily stores an enlarged or reduced image under the control of the output image FIFO control unit 119, and transmits information to the memory 12 after a certain amount of information is stored. The output image FIFO control unit 119 temporarily stores the output image information 14 while checking the free space in the output image FIFO 118, and after a certain amount of information is stored, prompts the information writing control unit 117 to execute write control on the memory 12.

The input image format conversion unit 120 performs processing of converting the input image information 13 transmitted from the input image FIFO 115 into an image format based on subsequent processing.

The scaling calculation unit 121 receives the scale factor setting information from the scale factor information setting unit 18 and calculates the scale processing of the input image. More specifically, the scaling calculation unit 121 changes the image size of the input image information 13 transmitted from the input image format conversion unit 120 based on the specified enlargement ratio or reduction ratio. The scaling calculation unit 121 sets the changed input image information 13 as the output image information 14, and transmits the output image information 14 based on the output image area.

The output image format conversion unit 122 converts the output image information 14 transmitted from the scaling calculation unit 121 into an image format based on the subsequent processing.

The flow control unit 123 controls the entire image processing circuit 15 on the basis of an instruction from the CPU 11. In addition, the flow control unit 123 reads an appropriate descriptor list from the descriptor lists 124a to 124n in the memory 12, decodes the contents of the descriptor list, and sets various registers specified in the image processing circuit 15.

Furthermore, FIG. 1 illustrates paths S1 to S10. The path S1 indicates a path for setting parameters for the image processing circuit 15 from the CPU 11.

The path S2 is a path for setting parameters in the input image area comparison unit 112. Parameters set in the path S2 are, for example, IMG_IN_HSIZE and IMG_IN_VSIZE. IMG_IN_HSIZE indicates the number of pixels or the number of required bytes of the input image in the horizontal direction. IMG_IN_VSIZE indicates the number of pixels or the number of required bytes of the input image in the vertical direction.

The path S3 is a path for setting parameters in the optimized image area calculation unit 111. Parameters set in the path S3 are, for example, IMG_HSCALE and IMG_VSCALE. IMG_HSCALE indicates an enlargement ratio or reduction ratio of the input image in the horizontal direction. IMG_VSCALE indicates an enlargement ratio or reduction ratio of the input image in the vertical direction.

The path S4 is a path for setting parameters in the optimized image area calculation unit 111. Parameters set in the path S4 are, for example, IMG_OUT_HSIZE and IMG_OUT_VSIZE. IMG_OUT_HSIZE indicates the number of pixels or the number of required bytes of the output image in the horizontal direction. IMG_OUT_VSIZE indicates the number of pixels or the number of required bytes of the output image in the vertical direction.

The path S5 is a path for setting, in the information reading control unit 114, parameters indicating the size of the input image after comparative update updated by the input image area comparison unit 112. Parameters set in the path S5 are, for example, IMG_IN_HSIZE_RENEW and IMG_IN_VSIZE_RENEW. IMG_IN_HSIZE_RENEW indicates the number of pixels or the number of required bytes of the updated input image in the horizontal direction. IMG_IN_VSIZE_RENEW indicates the number of pixels or the number of required bytes of the updated input image in the vertical direction.

The path S6 is a path for setting parameters in the information reading control unit 114. Parameters set in the path S6 include, for example, IMG_IN_STADD. IMG_IN_STADD indicates the start address when the input image information 13 is read from the memory 12.

The path S7 is a path for setting parameters in the input image format conversion unit 120. Parameters set in the path S7 include, for example, IMG_IN_FMT. IMG_IN_FMT indicates the image format of the input image.

The path S8 is a path for setting parameters in the output image format conversion unit 122. Parameters set in the path S8 include, for example, IMG_OUT_FMT. IMG_OUT_FMT indicates the image format of the output image.

The path S9 is a path for setting parameters in the information writing control unit 117. Parameters set in the path S9 include, for example, IMG_OUT_STADD. IMG_OUT_STADD indicates the start address when the output image is written.

The path S10 is a path for setting the calculation results calculated by the optimized image area calculation unit 111 in the input image area comparison unit 112. The calculation results set in the path S10 are, for example, CAL_IN_HSIZE and CAL_IN_VSIZE. CAL_IN_HSIZE indicates the number of pixels or the number of required bytes of the input image in the horizontal direction after the processing of the optimized image area calculation unit 111. CAL_IN_VSIZE indicates the number of pixels or the number of required bytes of the input image in the vertical direction after the processing of the optimized image area calculation unit 111.

### Image Processing of Semiconductor Device

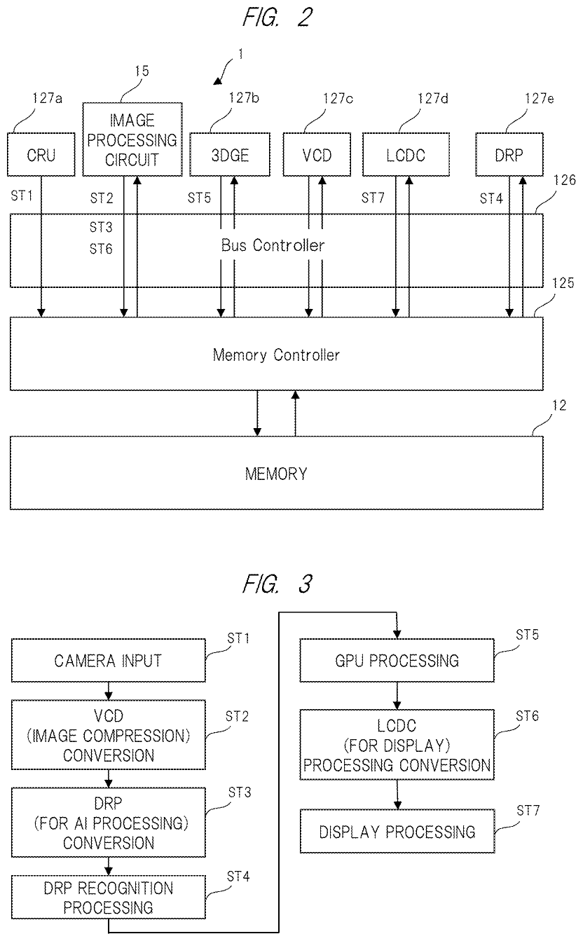

FIG. 2 is a diagram for explaining an example of image processing of the semiconductor device 1.

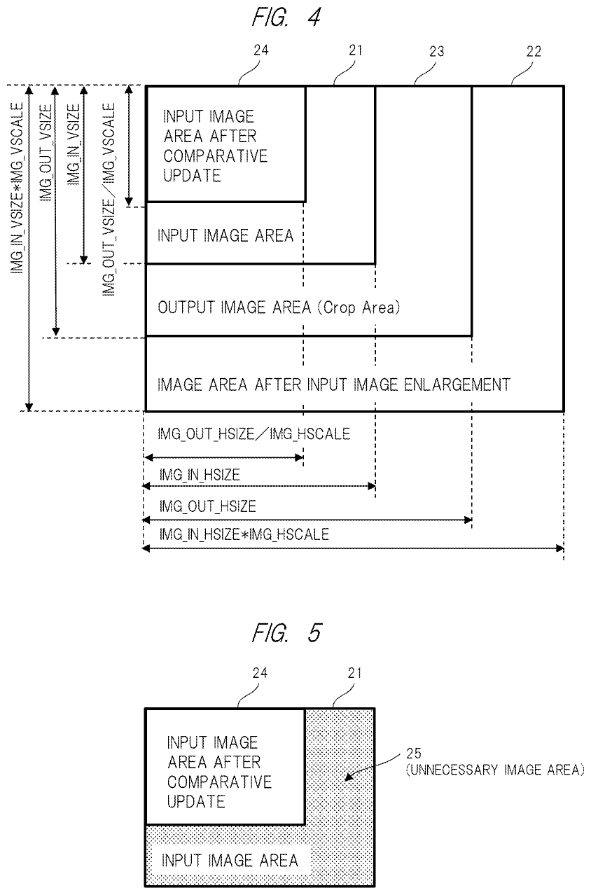

The semiconductor device 1 includes a CRU 127a, a 3DGE 127b, a VCD 127c, an LCDC 127d, and a DRP 127e as examples of the other IPs 127. In the semiconductor device 1, in addition to the image processing circuit 15, the CRU 127a, the 3DGE 127b, the VCD 127c, the LCDC 127d, and the DRP 127e can access the memory 12 via the bus controller 126 and the memory controller 125. Note that the processing of steps ST1 to ST7 illustrated in FIG. 2 will be described later with reference to FIG. 3.

The CRU 127a is a camera device that captures an image. The 3DGE 127b is a device that performs GPU processing. The VCD 127c is a device that performs image compression. The LCDC 127d is a liquid crystal display device that displays an image. The DRP 127e is a device that performs conversion for AI processing.

Next, an example of image processing when the semiconductor device 1 outputs an input image captured from the camera device to the liquid crystal display device will be described. FIG. 3 is a flowchart illustrating an example of image processing of the semiconductor device 1. As illustrated in FIG. 3, in step ST1, the captured input image captured by the CRU 127a is stored in the memory 12. Next, in step ST2, the input image is read from the memory 12 by the image processing circuit 15, and subsequent processing, that is, image processing for VCD (image compression) conversion is performed, and the image subjected to the processing is stored in the memory 12.

Next, in step ST3, the input image stored in the memory 12 is read by the image processing circuit 15, and subsequent processing, that is, image processing for DRP (for AI processing) conversion is performed, and the image subjected to the processing is stored in the memory 12. Next, in step ST4, the converted image is read from the memory 12 by the DRP 127e, DRP recognition processing is performed on the read input image, and the recognition result is stored in the memory 12. The recognition result is, for example, coordinates of vertices at which the object is recognized.

Next, in step ST5, the recognition result in step ST4 stored in the memory 12, for example, the coordinates (vertex coordinate information) of vertices and the like are read by the 3DGE 127b, GPU processing of drawing a quadrangle or the like connecting the vertices from the read vertex coordinate information is performed, and the image subjected to the GPU processing is stored in the memory 12. Next, in step ST6, the input image stored in the memory 12 is read by the image processing circuit 15, processing of converting the image size in order to superimpose the image subjected to the GPU processing on an LCDC display image is performed, and the image subjected to the processing is stored in the memory 12.

Next, in step ST7, the input image processed in step ST1 and stored in the memory 12 and the input image processed in step ST6 are read by the LCDC 127d, and combining processing is performed in the LCDC 127d in a manner that two images become one image, and the resultant image is displayed on the liquid crystal display device as a combined image.

As described above, in the image processing of the semiconductor device 1, the memory 12 is frequently accessed by the image processing circuit 15. For this reason, when the amount of information increases due to high definition of the input image, it is necessary to read a large amount of information from the memory 12 or write a large amount of information to the memory 12, and the load on the image processing circuit 15 increases.

### Image Area Used for Image Processing

Next, an image area used for image processing in a case where the image processing circuit 15 performs image processing will be described. In the present embodiment, an example in which an input image is enlarged will be described. FIG. 4 is a diagram for explaining an example of the image area.

As illustrated in FIG. 4, an input image area 21, an enlarged input image area 22, an output image area (Crop Area) 23, and an input image area 24 after comparative update are illustrated. The magnitude relationship among the input image area 21, the input image area 22 after input image enlargement, the output image area (Crop Area) 23, and the input image area 24 after comparative update is the input image area 24 after comparative update<the input image area 21<the output image area 23<the input image area 22 after input image enlargement. In FIG. 4, the left-right direction indicates the horizontal direction, and the up-down direction indicates the vertical direction. The same applies to the following cases.

In the input image area 21, the size in the horizontal direction is indicated by IMG_IN_HSIZE, and the size in the vertical direction is indicated by IMG_IN_VSIZE. In the input image area 22, the size in the horizontal direction is indicated by IMG_IN_HSIZE*IMG_HSCALE, and the size in the vertical direction is indicated by IMG_IN_VSIZE*IMG_VSCALE. In the output image area (Crop Area) 23, the size in the horizontal direction is indicated by IMG_OUT_HSIZE, and the size in the vertical direction is indicated by IMG_OUT_VSIZE. In the input image area 24, the size in the horizontal direction is indicated by IMG_OUT_HSIZE/IMG_HSCALE, and the size in the vertical direction is indicated by IMG_OUT_VSIZE/IMG_VSCALE.

The input image area 21 indicates the image area of the input image information 13. The area required as the output image is the output image area 23. In a case where the input image area 21 is enlarged at the set enlargement ratio, the input image area becomes the enlarged input image area 22. On the other hand, even if the image area is enlarged like the input image area 22, the area of the output image remains as the output image area 23. Accordingly, in order to output the output image of the output image area 23, the entire range of the input image area 22 may be unnecessary. That is, in a case where the input image is enlarged and the output image is output as the output image area 23, there is an image area unnecessary for image processing in the input image area 21. Note that, in the present embodiment, a case where the input image is enlarged will be described. However, also in a case where the input image is reduced, there may be an image area unnecessary for image processing in the input image area 21.

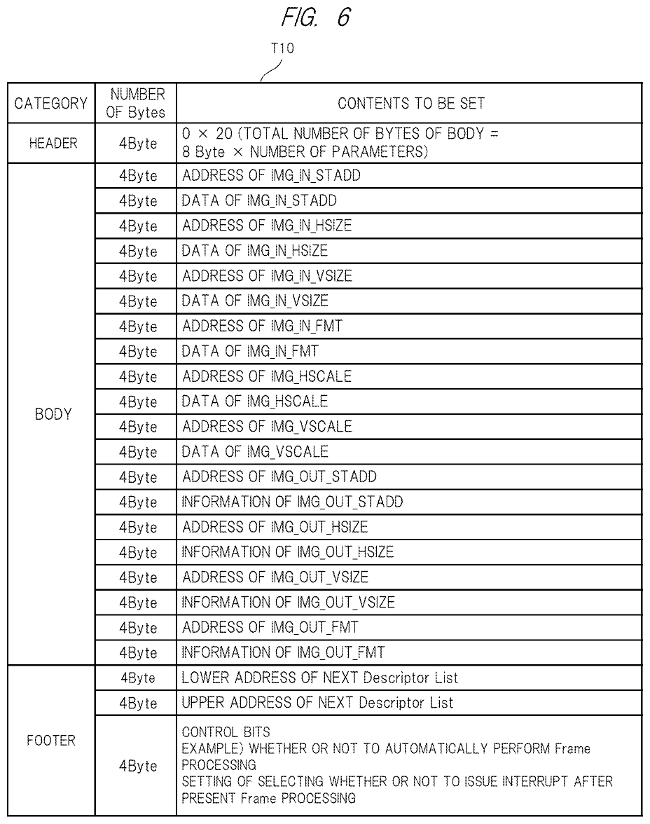

FIG. 5 is a diagram illustrating an example of an unnecessary image area in the case illustrated in FIG. 4. As illustrated in FIG. 5, in this example, the area that is an outer portion of the input image area 24 after comparative update in the input image area 21 is an unnecessary image area 25. In FIG. 5, the unnecessary image area 25 is represented with dots.

### Before Start of Image Processing

Next, setting processing of setting parameters and the like before the image processing circuit 15 performs image processing in the semiconductor device 1 will be described. The setting processing is performed by the CPU 11, the parameter storage unit 16, the flow control unit 123, the memory controller 125, the bus controller 126, and the descriptor list 124a illustrated in FIG. 1.

### Setting Before Image Processing and Description of Descriptor List

In the semiconductor device 1, various parameters are set in and control instructions are given to the image processing circuit 15 for the input and output of one image.

First, before the image processing circuit 15 starts processing, the CPU 11 initializes the flow control unit 123. In this initialization, the CPU 11 performs ON and OFF setting of an interrupt signal generated in the image processing circuit 15, setting of an address stored in the descriptor list 124a, and the like. When the initialization is completed, the CPU 11 instructs the flow control unit 123 to start up. A series of processing is performed in the path S1. The parameter is written in the path S1 via the bus controller 126. Note that writing may be performed in accordance with a protocol such as APB/AHB/AXI defined in the AMBA standard.

When receiving the start-up instruction, the flow control unit 123 reads the descriptor list 124a stored in the memory 12. Since the CPU 11 has previously stored, in the flow control unit 123, the address of the descriptor list 124a as the read destination, the flow control unit 123 starts accessing the address.

In a case where the access starts, first, an access request is transmitted from the flow control unit 123 to the bus controller 126. The bus controller 126 performs access prioritization in a case where an access request from an IP other than the flow control unit 123, for example, from an IP of the other IPs 127 overlaps with respect to the memory 12. In a case where the other IPs have accessed, the bus controller 126 waits until the transaction processing is completed. When the order comes, the bus controller 126 then makes a read access request to the memory controller 125.

The memory controller 125 executes read control on the memory 12. This read control is executed based on the type of the memory 12. In general, SRAM, DRAM, or the like is considered as the memory 12. Signal control is executed in accordance with the specifications of the memory 12. The information of the descriptor list 124a read from the memory 12 is temporarily taken into the flow control unit 123 via the memory controller 125 and the bus controller 126.

After analyzing the information of the header portion of the descriptor list 124a, the flow control unit 123 refers to the stored contents and stores the information in the specified register. Here, the descriptor list 124a will be described. FIG. 6 is a diagram illustrating an example of stored information T10 of the descriptor list 124a.

As illustrated in FIG. 6, a category, the number of bytes, and contents to be set are associated with each other in the stored information T10. The categories are a header, a body, and a footer. The number of bytes indicates the size of information of the contents to be set. Information based on the category is defined as the contents to be set.

In the header portion of the stored information T10 illustrated in FIG. 6, for example, the total number of bytes related to the body portion in the descriptor list 124a is defined. In the body portion, a combination of an address for designating a register in the image processing circuit 15 and information defining a parameter is defined. Based on this combination, the setting of the parameter of the specified register is changed. In the footer portion, an upper address and a lower address of the next descriptor list and control bits are defined. In the control bits, for example, setting as to whether or not to automatically perform frame processing is defined. This is a setting of selecting whether or not to issue an interrupt after the present frame processing. Other settings may be defined as the control bits. In addition, the example illustrated in FIG. 6 illustrates a case where ten parameters to be set in the parameter storage unit 16 are set.

In a case where there are an address and parameter information in the body portion, the flow control unit 123 stores the parameter in the register at the specified address on the basis of the address and the parameter information.

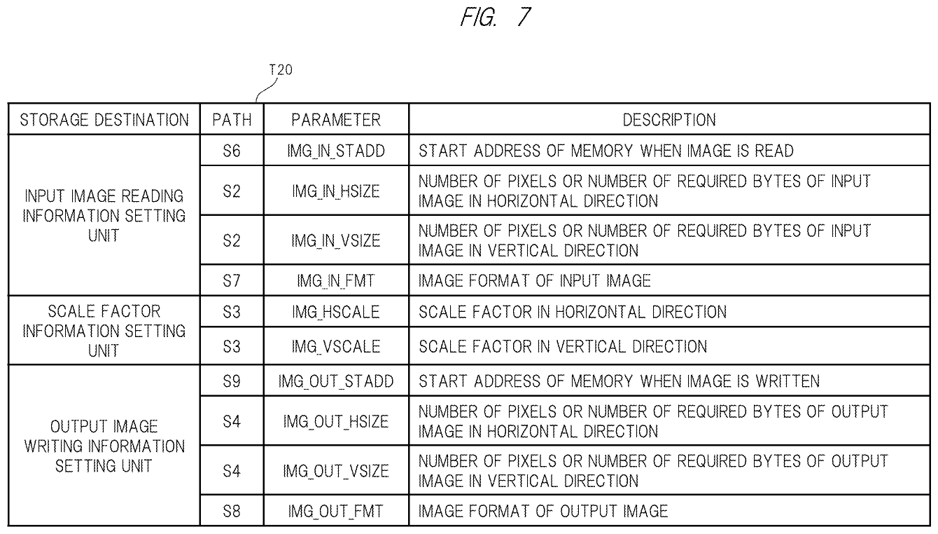

The relationship between the parameter and the storage destination address will be described in more detail. FIG. 7 is a diagram illustrating relationship information T20 that is an example of the relationship between a parameter and a storage destination address. As illustrated in FIG. 7, a storage destination, a path, a parameter, and a description are associated with each other in the relationship information T20. Note that the description portion does not need to be included in the relationship information T20.

The storage destination indicates a register or a circuit that sets parameters in the image processing circuit 15. In the example illustrated in FIG. 7, the input image reading information setting unit 17, the scale factor information setting unit 18, and the output image writing information setting unit 19 are defined as storage destinations. The path indicates a path for setting parameters. Any one of the paths S1 to S10 is defined based on the parameter. As the parameter, the parameter described above is defined. The description indicates the contents of the corresponding parameter.

For example, it is defined that IMG_HSCALE and IMG_VSCALE are set in the scaling calculation unit 121 by the path S3.

### Description of Parameters Before Image Processing

Various parameters are set in the parameter storage unit 16. In the present embodiment, as illustrated in FIG. 1, the parameter storage unit 16 includes the input image reading information setting unit 17, the scale factor information setting unit 18, and the output image writing information setting unit 19, which are minimum required for image processing.

In the input image reading information setting unit 17, for example, a start address IMG_IN_STADD of the memory 12 at the time of reading the input image information 13, the number of pixels or the number of required bytes in the horizontal direction IMG_IN_HSIZE, the number of pixels or the number of required bytes in the vertical direction IMG_IN_VSIZE, image format information IMG_IN_FMT indicating components of the input image information 13, and the like are set.

In the scale factor information setting unit 18, setting information related to the scale factor in the horizontal direction IMG_HSCALE, information related to the scale factor in the vertical direction IMG_VSCALE, and the like are set.

In the output image writing information setting unit 19, the number of pixels or the number of required bytes in the horizontal direction IMG_OUT_HSIZE and the number of pixels or the number of required bytes in the vertical direction IMG_OUT_VSIZE, which indicate which portion is cut out and output from the input image area 22 after scaling processing, the address of the start address IMG_OUT_STADD when these images are written in the memory 12, and the like, are set. In a case where the scaled image is smaller than the value set in this manner, processing of generating and filling pixels by a method specified in advance is performed. On the other hand, in a case where the scaled image is larger than the specified area, processing of outputting only the specified area portion is performed. Details of the processing will be described later.

### Footer Processing of Descriptor List

When the storage of the information defined in the body portion of the descriptor list 124a ends, the footer processing is started. Here, after image processing on one image is completed, the address of the storage destination of the next descriptor list 24b is temporarily stored in the flow control unit 123.

In a case where “yes” is selected in the setting as to whether or not to automatically perform Frame processing in the contents of the footer portion, the processing of the image processing circuit 15 is started. If “no” is selected in the setting as to whether or not to automatically perform Frame processing, the processing enters a standby state for a certain period. In this case, when a start-up request is received from the CPU 11, the processing of the image processing circuit 15 is started. When a start instruction is given, calculation processing of a necessary image is started.

### Calculation of Necessary Image Area

Hereinafter, for the processing of calculating the image area necessary for outputting the output image, two cases, that is, a first example and a second example will be described.

### First Example

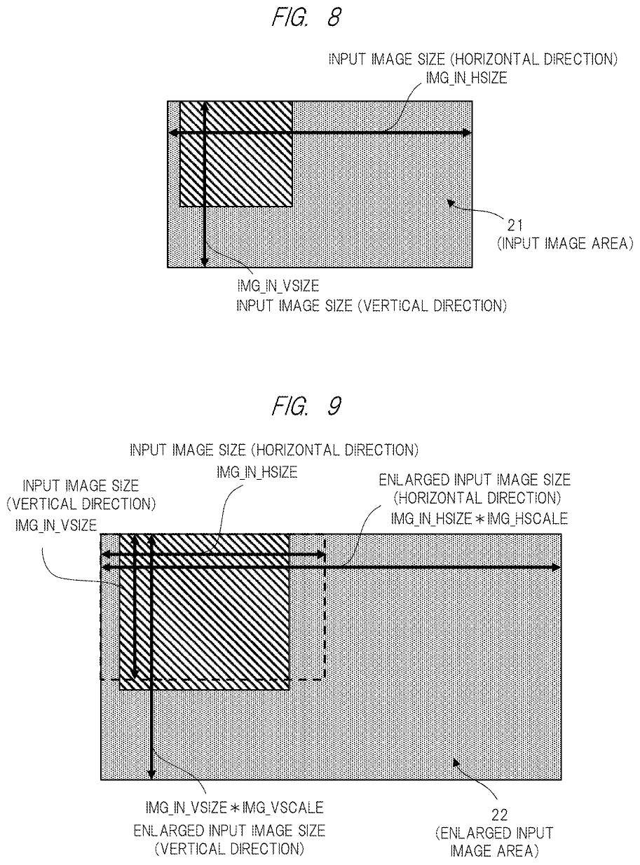

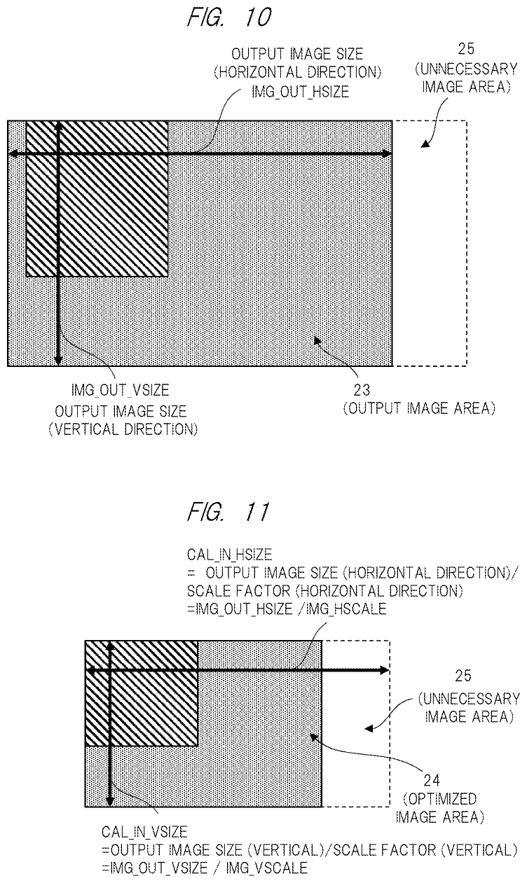

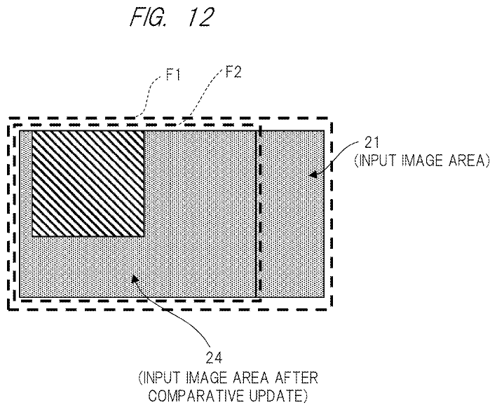

First, calculation processing of a necessary image area in the first example will be described. FIGS. 8 to 12 are diagrams for explaining calculation of a necessary image area. FIG. 8 is a diagram illustrating an image area of an input image. FIG. 9 is a diagram illustrating a scale factor and an image area of an enlarged image. FIG. 10 is a diagram illustrating an image area of an output image. FIG. 11 is a diagram illustrating an image area after optimization calculation. FIG. 12 is a diagram illustrating an image area after comparative update.

### Calculation Processing of Necessary Image: See FIG. 8

When an instruction to start processing is given, the processing proceeds to the processing of the input image area determination unit 110.

As described above, the input image area determination unit 110 includes the optimized image area calculation unit 111 and the input image area comparison unit 112. In describing the processing of the input image area determination unit 110, reference is made to FIGS. 4, 5, and 8 to 12 described above. FIGS. 8 to 12 illustrate the sizes of the image areas in the processing order. It can also be said that FIG. 4 is an image diagram illustrating a state where the image areas of FIGS. 8 to 12 are superimposed. It can also be said that FIG. 5 described above is an image diagram illustrating an image area unnecessary to output as the output image information 14 with respect to the input image information 13.

The input image area 21 indicates the area corresponding to the input image information 13 stored in the memory 12. The input image information 13 in the first example includes parameters of the number of pixels in the horizontal direction IMG_IN_HSIZE and the number of pixels in the vertical direction IMG_IN_VSIZE. The setting of the parameters of the input image information 13 is stored in the input image reading information setting unit 17. The parameters of the input image information 13 are set in the input image area comparison unit 112 from the input image reading information setting unit 17 through the path S2 illustrated in FIG. 1.

### Calculation Processing of Necessary Image: See FIG. 9

The enlarged input image area 22 is expressed by the following formulas (1) and (2), where the scale factor in the horizontal direction is IMG_HSCALE and the scale factor in the vertical direction is IMG_VSCALE. The parameters of the enlarged input image area 22 are set in the optimized image area calculation unit 111 from the scale factor information setting unit 18 through the path S3 illustrated in FIG. 1.

Horizontal size after scaling=IMG_IN_HSIZE*IMG_HSCALE (1)

Vertical size after scaling=IMG_IN_VSIZE*IMG_VSCALE (2)

The size of the input image area 22 is obtained using the above formula (1) and the above formula (2). The input image area 22 is represented by the size in the horizontal direction after scaling×the size in the vertical direction after scaling.

### Calculation Processing of Necessary Image: See FIG. 10

Next, a case where the output image area 23 is set for the scaled input image area 22 will be described. In a device that outputs an input image as an output image, for example, a liquid crystal display device, the image size (output image area 23) to be displayed is usually determined in advance. Here, in a case where the enlarged input image area 22 is larger than the output device image size, the image area is cut out based on the image size of the output device. In addition, even if no output device is provided, the same applies to a case where another image processing is performed at the subsequent stage of the image processing circuit 15. For example, as other examples, there are a case where the image size (output image area 23) of image processing is determined, a case where the image size (output image area 23) is limited to an integral multiple of 16, and the like.

Therefore, in the first example, the size of the output image area 23 is set in the output image writing information setting unit 19. When the image size in the horizontal direction is represented by IMG_OUT_HSIZE and the image size in the vertical direction is represented by IMG_OUT_VSIZE in a case where the output image information 14 is output, the size of the output image information 14 is represented by the output image area (Crop Area) 23 in FIG. 4 described above. The parameters for outputting the output image information 14 are set in the optimized image area calculation unit 111 from the output image writing information setting unit 19 through the path S4 illustrated in FIG. 1. The output image area 23 illustrated in FIG. 10 corresponds to an area obtained by cutting the unnecessary image area 25 from the enlarged input image area 22 illustrated in FIG. 5. When comparing the two figures, since there is no unnecessary image area in the vertical direction, in FIG. 10, the image area in the horizontal direction is the unnecessary image area 25.

In a case where the enlarged input image area 22 is smaller than the output image area 23, insufficient pixel information is filled and output. In the first example, insufficient pixel information for filling is generated in the image processing circuit 15. As another method, for example, a method can be considered in which a register is separately provided in the parameter storage unit 16 in advance, and color information of pixels to be filled is set in the register. In general, such processing is called PADDING processing.

### Calculation Processing of Necessary Image: See FIG. 11

Next, the function of the optimized image area calculation unit 111 will be described. By calculating a value obtained by dividing the output image area 23 set by the output image writing information setting unit 19 by the scale factor in the horizontal direction IMG_HSCALE and the scale factor in the vertical direction IMG_VSCALE, which are set by the scale factor information setting unit 18, the optimized image area calculation unit 111 can calculate the input image area 24 after comparative update. The input image area 24 after optimization image area calculation is expressed by the following formulas (3) and (4), where the image size in the horizontal direction is CAL_IN_HSIZE and the image size in the vertical direction is CAL_IN_VSIZE.

CAL_IN_HSIZE=IMG_OUT_HSIZE/IMG_HSCALE (3)

CAL_IN_VSIZE=IMG_OUT_VSIZE/IMG_VSCALE (4)

In the above calculation, in a case where the output image of the output image area 23 is output, what size of image area in the input image area 21 is required is calculated from the scale factor. The input image area 24 after calculation illustrated in FIG. 11 corresponds to FIG. 5 described above.

As described above, the optimized image area calculation unit 111 divides the scale factors IMG_HSCALE and IMG_VSCALE in the horizontal direction and the vertical direction on the basis of the output image area sizes IMG_OUT_HSIZE and IMG_OUT_VSIZE. As a result, the optimized image area calculation unit 111 can obtain the minimum required input image area for the image output, that is, the input image area 24 after comparative update. CAL_IN_HSIZE and CAL_IN_VSIZE, which are calculation results calculated by the optimized image area calculation unit 111, are transmitted to the input image area comparison unit 112 through the path S10.

Calculation Processing of Necessary Image after Start of Processing: See FIG. 12

Next, the function of the input image area comparison unit 112 will be described.

The parameters (IMG_IN_HSIZE and IMG_IN_VSIZE) set in the input image reading information setting unit 17 are input to the input image area comparison unit 112 through the path S2. On the other hand, the calculation result calculated by the optimized image area calculation unit 111, that is, the size (CAL_IN_HSIZE and CAL_IN_VSIZE) after optimized image calculation is input to the input image area comparison unit 112 through the path S10.

The input image area comparison unit 112 compares the sizes in the horizontal direction and the vertical direction on the basis of the input parameters and the calculation results. In the horizontal direction, the input image area comparison unit 112 compares IMG_IN_HSIZE with CAL_IN_HSIZE, and stores a smaller value as IMG_IN_HSIZE_RENEW. In the vertical direction, the input image area comparison unit 112 compares IMG_IN_VSIZE with CAL_IN_VSIZE, and stores a smaller value as IMG_IN_VSIZE_RENEW. This processing means that, in a case where the calculation result of the optimized image area calculation unit 111 is smaller than the parameter set in the input image reading information setting unit 17, it is only required to read the image area portion in the input image area 24 after comparative update, which is smaller than the input image area 21, from the memory 12.

In FIG. 12, dotted frames F1 and F2 are illustrated. The dotted frame F1 indicates the input image area 21 defined by CAL_IN_HSIZE and CAL_IN_VSIZE. The dotted frame F2 indicates the input image area 24 after comparative update defined by IMG_IN_HSIZE and IMG_IN_VSIZE. The input image area comparison unit 112 selects an image area with a smaller calculation result from the two image areas. In the first example, the input image area 24 after comparative update indicated by the frame F2 is selected. Here, the stored CAL_IN_HSIZE and CAL_IN_VSIZE become IMG_IN_HSIZE_RENEW and IMG_IN_VSIZE_RENEW. IMG_IN_HSIZE_RENEW and IMG_IN_VSIZE_RENEW are transmitted to the information reading control unit 114 through the path S5 and used for subsequent processing.

As described above, in the image processing circuit 15, the input image area 21 is replaced with the input image area 24 after comparative update, which is a necessary image input area, so that it is not necessary to read the unnecessary image area 25 from the memory 12, and the bandwidth can be reduced. The reduction amount RA indicating the amount of bandwidth reduction is obtained by the following formula (5).

$$[ Math . 1 ]$$

$$R A = \frac{( IMG\_OUT \_HSIZE / IMG\_HSCALE ) * ( IMG\_OUT \_VSIZE / IMG\_VSCALE )}{IMG\_IN \_HSIZE * IMG\_IN \_VSIZE} = \frac{IMG\_OUT \_HSIZE * IMG\_OUT \_VSIZE}{( IMG\_IN \_HSIZE / IMG\_HSCALE ) * ( IMG\_IN \_VSIZE / IMG\_VSCALE )} \qquad ( 5 )$$

### Calculation Example Based on Actual Size Example in Calculation Processing of Necessary Image

Specific calculation in the processing of step ST7 illustrated in FIG. 3 will be described. The processing of step ST7 is image processing in a case where an image is displayed by the LCDC 127d.

First, specifications will be described. The input image area of the input image information 13 has 1920×1080 pixels (IMG_IN_HSIZE=1920, and IMG_IN_VSIZE=1080), the output image area has 2560×1600 pixels (IMG_OUT_HSIZE=2560, and IMG_OUT_VSIZE=1600), and the enlargement ratio is 1.4815×1.4815 (IMG_HSCALE=1.4815, and IMG_VSCALE=1.4815). As the enlargement ratio, the ratio in the vertical direction is obtained, and the aspect ratio in the vertical and horizontal directions is fixed.

### Calculation Example of Calculation Processing of Necessary Image

First, calculation in the horizontal direction will be described. The size of the input image is a parameter set in the input image reading information setting unit 17, and the size of the calculation result (CAL_IN_HSIZE) is a result calculated by the optimized image area calculation unit 111 using formulas (1) and (3).

$$Size in horizontal direction after scaling : IMG\_IN \_HSIZE * IMG\_HSCALE = 1920 * 1.4815 \approx 2844$$

$$Size of calculation result : IMG\_OUT \_HSIZE / IMG\_HSCALE = 2560 / 1.4815 \approx 1728$$

As a result, since the size CAL_IN_HSIZE (1728) of the calculation result is smaller than the size IMG_IN_HSIZE (1920) of the input image, the input image area comparison unit 112 can optimize the read size in the horizontal direction and updates the parameter. That is, the input image area comparison unit 112 updates the value (1728) of the calculation result CAL_IN_HSIZE from the value (1920) of IMG_IN_HSIZE to be IMG_IN_HSIZE_RENEW (1728).

Next, calculation in the vertical direction will be described. The size of the input image is a parameter set in the input image reading information setting unit 17, and the size of the calculation result (CAL_IN_VSIZE) is a result calculated by the optimized image area calculation unit 111 using formulas (2) and (4).

$$Vertical size after scaling : IMG\_IN \_VSIZE * IMG\_VSCALE = 1080 * 1.4815 \approx 1600$$

$$Size of calculation result : IMG\_OUT \_VSIZE / IMG\_VSCALE = 1600 / 1.4815 \approx 1080$$

As a result, since the size (1080) of IMG_IN_VSIZE of the input image is the same as the size (1080) of CAL_IN_VSIZE of the calculation result, the input image area comparison unit 112 keeps the read size in the vertical direction at 1080. That is, the input image area comparison unit 112 keeps the value (1080) of the calculation result CAL_IN_VSIZE at the value (1080) of IMG_IN_VSIZE and obtains IMG_IN_VSIZE_RENEW (1080).

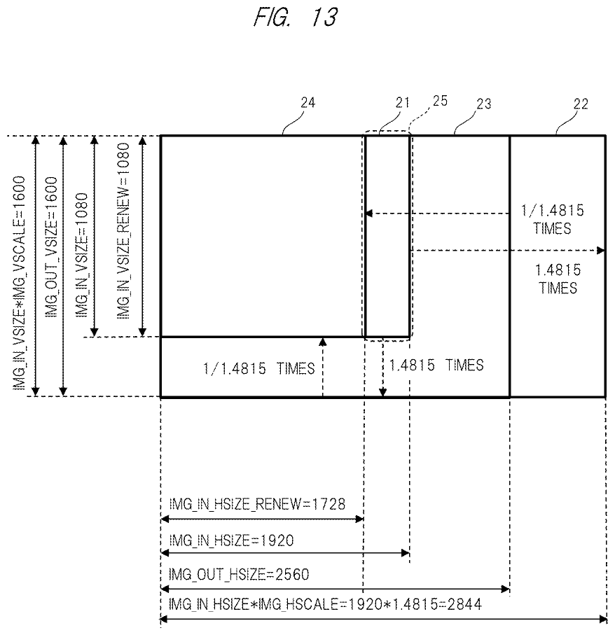

FIG. 13 is a schematic diagram illustrating an example of specifications and calculation results. As illustrated in FIG. 13, the size of the input image area 21 is “IMG_IN_HSIZE=1920” in the horizontal direction and “IMG_IN_VSIZE=1080” in the vertical direction. The size of the enlarged input image area 22 is “IMG_IN_HSIZE*IMG_HSCALE=1920*1.4815=2844” in the horizontal direction and “IMG_IN_VSIZE*IMG_VSCALE=1600” in the vertical direction. The size of the output image area 23 is “IMG_OUT_HSIZE=2560” in the horizontal direction and “IMG_OUT_VSIZE=1600” in the vertical direction. The size of the input image area 24 after comparative update is “IMG_IN_HSIZE_RENEW=1728” in the horizontal direction and “IMG_IN_VSIZE_RENEW=1080” in the vertical direction. The unnecessary image area 25 is an area surrounded by a broken line frame in the figure.

The enlarged input image area 22 is enlarged from the input image area 21 by a factor of 1.4815 in the horizontal direction and the vertical direction. In addition, the input image area 24 is reduced from the enlarged input image area 22 by a factor of 1/1.4815 in the horizontal direction and the vertical direction.

By performing the above processing, the image processing circuit 15 can reduce the number of pixels of the input image information 13 read from the memory 12 by (1920−1728)×1080=207,360 pixels. Furthermore, the bandwidth is (1920−1728)/1920=0.10, and the image processing circuit 15 can reduce the bandwidth of the input image information 13 read from the memory 12 by 10%. Therefore, the semiconductor device 1 including the image processing circuit 15 can reduce the amount of access to the memory 12 and reduce the load on the image processing circuit 15.

### Second Example

Next, a second example will be described. In the first example, an example in which the semiconductor device 1 performs processing in accordance with the descriptor list 124a illustrated in FIG. 6 has been described. The address for reading the next descriptor list is stored in the last footer portion of the frame of the descriptor list 124a. In the second example, a case where the descriptor list 124n is stored as the next descriptor list will be described. Hereinafter, how the size of the input image area used as the output image changes in a case where the descriptor list 124n is used will be described.

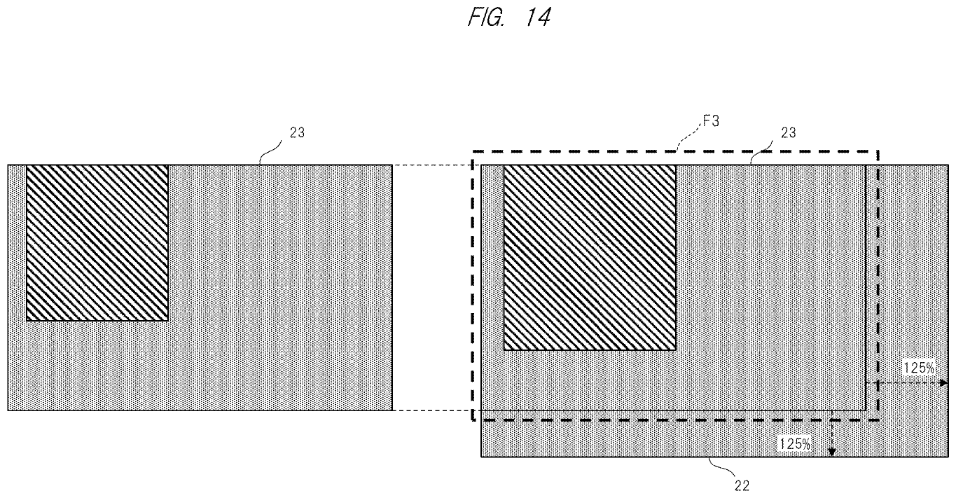

The second example will be described by using an example in which the size of the input image information 13 is enlarged to 125% in each of the horizontal direction and the vertical direction as compared with the first example. FIG. 14 is a diagram comparing the output image area 23 of the first example with an output image area 23a of the second example. Since the monitor size of the LCDC 127d (liquid crystal display device) is the same as that in the first example, as illustrated in FIG. 14, the output image area 23 in a frame F3 with the same size as the output image area 23 of the first example is an output image area required to be output in the second example. That is, the image of the output image area 23 that is the same as that in the first example is displayed on the liquid crystal display device, and the image outside the frame F3 is not displayed. Therefore, in the input image area 22 enlarged by 125%, unnecessary image areas are generated in the horizontal direction and the vertical direction.

Calculation Example Based on Actual Size Example in Calculation Processing of Necessary Image after Start of Processing

As in the case of the first example, specific calculations of the processing of step ST7 in FIG. 3 will be described. Step ST7 is image processing in a case where the display processing of the LCDC 127d is performed.

First, specifications will be described. The input image area of the input image information 13 has 1920×1080 pixels (IMG_IN_HSIZE=1920, and IMG_IN_VSIZE=1080), the output image area has 2560×1600 pixels (IMG_OUT_HSIZE=2560, and IMG_OUT_VSIZE=1600), and the enlargement ratio is 1.8519×1.8519 (IMG_HSCALE=1.8519, and IMG_HSCALE=1.8519). The enlargement in the horizontal direction and the vertical direction is performed at a factor of 1.25 (1.4181×1.25 for the original input image) as compared with the first example. That is, the enlargement ratio corresponds to 125% on the monitor of the liquid crystal display device.

### Description List 124n

In the descriptor list 124n, in the second example, by correcting the following four parameters, the input image information 13 can be enlarged by a factor of 1.25 as compared with the first example.
Parameter “IMG_IN_STADD”: start address of the memory 12 when the input image is read
Parameter “IMG_OUT_STADD”: start address of the memory 12 when the output image is written
Parameter “IMG_HSCALE”: scale factor in the horizontal direction
Parameter “IMG_VSCALE”: scale factor in the vertical direction

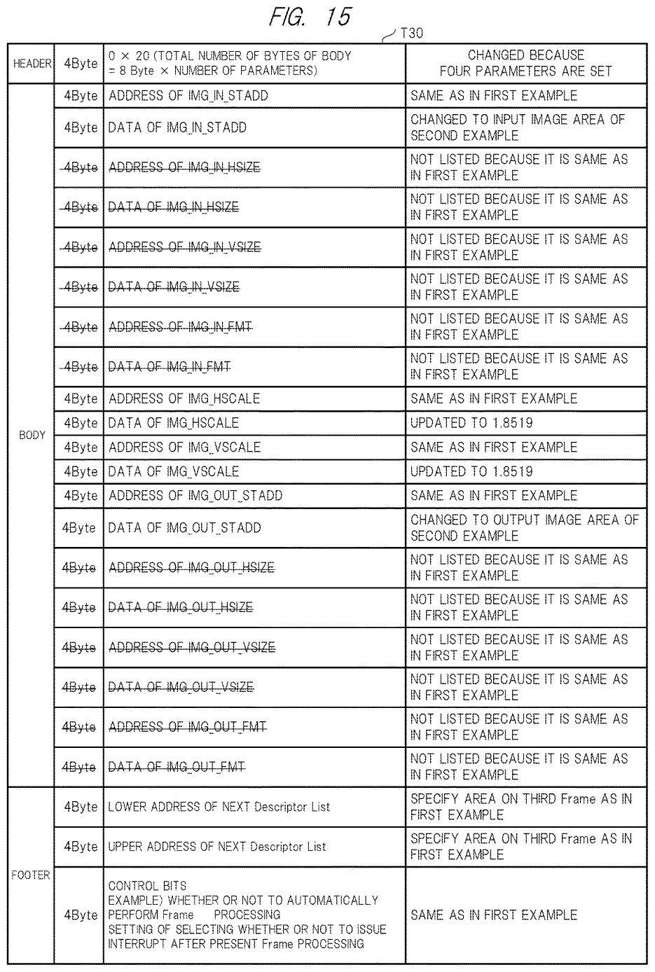

Since parameters other than the above are not corrected, the descriptor list 124n is represented as illustrated in FIG. 15. FIG. 15 is a diagram illustrating an example of stored information T30 of the descriptor list 124n in the second example. The parameters other than the above changed parameters are the same as those in FIG. 6. In the descriptor list 124n, the field “update contents from first example” for describing differences from the descriptor list 124a in FIG. 6 is stored for description, but the field does not need to be provided.

### Calculation Example of Calculation Processing of Necessary Image

First, calculation in the horizontal direction will be described. The size of the input image is a parameter set in the input image reading information setting unit 17, and the size of the calculation result (CAL_IN_HSIZE) is a result calculated by the optimized image area calculation unit 111 using formulas (1) and (3).

$$Horizontal size after scaling : IMG\_IN \_HSIZE * IMG\_HSCALE = 1920 * 1.8519 \approx 3556$$

$$Size of calculation result : IMG\_OUT \_HSIZE / IMG\_HSCALE = 2560 / 1.8519 \approx 1382$$

As a result, since the size CAL_IN_HSIZE (1382) of the calculation result is smaller than the size IMG_IN_HSIZE (1920) of the input image, the input image area comparison unit 112 can optimize the read size in the horizontal direction and updates the parameter. That is, the input image area comparison unit 112 updates the value (1382) of the calculation result CAL_IN_HSIZE from the value of IMG_IN_HSIZE (1920) to be IMG_IN_HSIZE_RENEW (1382).

Next, calculation in the vertical direction will be described. The size of the input image is a parameter set in the input image reading information setting unit 17, and the size of the calculation result (CAL_IN_VSIZE) is a result calculated by the optimized image area calculation unit 111 using formulas (2) and (4).

$$Vertical size after scaling : CAL\_IN \_VSIZE * IMG\_VSCALE = 1080 * 1.8519 \approx 2000$$

$$Size of calculation result : IMG\_OUT \_VSIZE / IMG\_VSCALE = 1600 / 1.8519 \approx 863$$

As a result, since the size (863) of CAL_IN_VSIZE of the calculation result is smaller than the size (1080) of IMG_IN_VSIZE of the input image, the input image area comparison unit 112 can optimize the read size in the vertical direction, and updates the parameter. That is, the input image area comparison unit 112 updates the value (863) of the calculation result CAL_IN_VSIZE from the value (1080) of IMG_IN_VSIZE to be IMG_IN_HSIZE_RENEW (863).

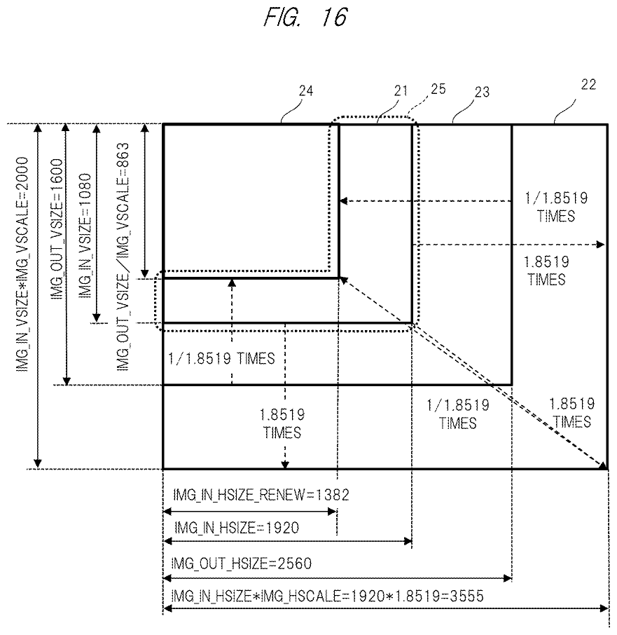

FIG. 16 is a schematic diagram illustrating an example of specifications and calculation results. As illustrated in FIG. 16, the size of the input image area 21 is “IMG_IN_HSIZE=1920” in the horizontal direction and “IMG_IN_VSIZE=1080” in the vertical direction. The size of the enlarged input image area 22 is “IMG_IN_HSIZE*IMG_HSCALE=1920*1.8519=3555” in the horizontal direction and “IMG_IN_VSIZE*IMG_VSCALE=2000” in the vertical direction. The size of the output image area 23 is “IMG_OUT_HSIZE=2560” in the horizontal direction and “IMG_OUT_VSIZE=1600” in the vertical direction. The size of the input image area 24 after comparative update is “IMG_IN_HSIZE_RENEW=1382” in the horizontal direction and “IMG_OUT_VSIZE/IMG_VSCALE=863” in the vertical direction. The unnecessary image area 25 is an area surrounded by a broken line frame in the figure.

The enlarged input image area 22 is enlarged from the input image area 21 by a factor of 1.8519 in the horizontal direction. In addition, the input image area 24 is reduced from the enlarged input image area 22 by a factor of 1/1.8519 in the horizontal direction and the vertical direction.

By performing the above processing, the image processing circuit 15 can reduce the number of pixels of the input image information 13 read from the memory 12 by (1920−1382)×863+1920×(1080−863)=880,934 pixels. Furthermore, the bandwidth is 880934/(1920−1080)=0.42, and the image processing circuit 15 can reduce the bandwidth of the input image by 42%. Therefore, the semiconductor device 1 including the image processing circuit 15 can reduce the load on the image processing circuit 15.

### Effects

The semiconductor device 1 including the image processing circuit 15 that performs image processing such as scaling can calculate the optimized input image area 24 from the ratio of the scale factors of the output image area 23 and the input image area 21. As a result, the image processing circuit 15 can access the pixels of the image area 25 that is truly necessary from the input image information 13, and can reduce the bandwidth for accessing the memory 12.

Furthermore, by reducing the access bandwidth to the memory 12, the image processing circuit 15 can improve the processing speed from the input of an image to the output of the processed image.

Moreover, the image processing circuit 15 can automatically calculate the image size to be read easily only by adding processing of changing the setting of the scale factor without applying a load to the CPU 11. As described above, the processing of the image processing circuit 15 can also be reduced without applying a load to the CPU 11, and the efficiency of the processing of the entire semiconductor device 1 can be improved.

While the definition of an image to be processed has been increased to 4K and 8K in recent years, the bandwidth of buses is extremely tight. Therefore, by applying the technique of the above disclosure, the semiconductor device 1 can largely reduce the amount of the input image information 13 to be accessed, and the efficiency of the buses to be used can be improved.

Although the invention made by the present inventors has been specifically described on the basis of the embodiments, the present invention is not limited to the above embodiments, and it goes without saying that various modifications can be made without departing from the gist of the present invention.

What is claimed is:

1. A semiconductor device comprising:
a register in which input image setting information including an input size of an image area of an input image to be read from a memory, scale factor setting information for setting a scale factor of the input image, and output image setting information including an output size of an image area of an output image to be output to the memory are set; and
an image processing circuit including a scaling unit that changes a size of the input image based on a scale factor set in the scale factor setting information, and performing image processing of the input image,
wherein the image processing circuit includes
a calculation unit that calculates a necessary image area size for outputting the output image based on the output size and the scale factor, and
a comparison unit that compares the necessary image area size with the input size, selects an image area with a smaller size out of the necessary image area size and the input size, and uses the selected image area for the image processing of the input image.

2. The semiconductor device according to claim 1,
wherein the comparison unit calculates the necessary image area size by dividing the output size by the scale factor.

3. The semiconductor device according to claim 1,
wherein the image processing circuit further includes an information reading control unit that executes control to read the input image from the memory, and
wherein the information reading control unit reads, from the memory, the input image of the image area selected by the comparison unit in the image area of the input image.

4. The semiconductor device according to claim 3, further comprising a scaling calculation unit that receives the scale factor setting information from the register and calculates scaling processing of the input image selected by the comparison unit,
wherein the scaling calculation unit scales the input image of the image area selected at the scale factor included in the scale factor setting information.

5. The semiconductor device according to claim 4, comprising an information writing control unit that executes control to write the output image to the memory,
wherein the information writing control unit outputs the scaled input image of the image area to the memory as the output image.

6. The semiconductor device according to claim 1,
wherein the register includes a first setting unit, a second setting unit, and a third setting unit,
wherein the input image setting information is set in the first setting unit,
wherein the scale factor setting information is set in the second setting unit,
wherein the output image setting information is set in the third setting unit,
wherein the comparison unit receives the input image setting information from the first setting unit, and
wherein the calculation unit receives the scale factor setting information from the second setting unit and receives the output image setting information from the third setting unit.

7. The semiconductor device according to claim 6,
wherein the memory stores a list including the input image setting information, the scale factor setting information, and the output image setting information, and
wherein the image processing circuit
reads the input image setting information, the scale factor setting information, and the output image setting information from the memory before reading the input image of the image area from the memory, and
sets the input image setting information, the scale factor setting information, and the output image setting information, which have been read, in the first setting unit, the second setting unit, and the third setting unit, respectively.

8. The semiconductor device according to claim 7,
wherein the memory includes a plurality of the lists,
wherein the list includes designation information designating the list in order to perform processing of the input image next, and
wherein the image processing circuit performs image processing of the input image based on the designation information included in the list.

9. The semiconductor device according to claim 1,
wherein the output size of the output image is determined based on a device connected to the semiconductor device.

10. The semiconductor device according to claim 1,
wherein the output size of the output image is determined based on processing at a subsequent stage of the image processing circuit.
